(19) United States
(12) Patent Application Publication
(10) Pub. No.: US 2020/0338379 A1
(43) Pub. Date: Oct. 29, 2020

(54) Trampoline Clamp

(71) Applicant: Samuel Chen, Causeway Bay (CN)

(72) Inventor: Samuel Chen, Causeway Bay (CN)

(21) Appl. No.: 16/393,001

(22) Filed: Apr. 24, 2019

(51) Int. Cl. A63B 5/11; A63B 21/055

(52) U.S. Cl. CPC A63B 5/11; F16B 2/245; A63B 21/0557

(57) ABSTRACT

A trampoline clamp structure has a trampoline bounding bed attached to a trampoline frame. Trampoline legs extending downwardly from the trampoline frame. The trampoline legs include a right trampoline leg and a left trampoline leg. A trampoline handle has a pair of downwardly extending posts, namely a right post and a left post. A right clamp has a right outside retainer and a right inside retainer. The right outside retainer retains the right post. The right inside retainer retains the right trampoline leg. A left clamp has a left outside retainer and a left inside retainer. The left outside retainer retains the left post. The left inside retainer retains the left trampoline leg. At least one right outside retainer tab is formed on the right clamp.

### FIELD OF THE INVENTION

The present invention is in the field of trampolines and trampoline connectors.

### DISCUSSION OF RELATED ART

A variety of different trampolines have handles connected to the trampolines. These handles are typically used in exercise. For example in U.S. Pat. No. 4,598,905 by inventor Vrana issued Jul. 8, 1986 entitled Trampoline Exercise Steadying Structure, the disclosure of which is incorporated herein by reference, a handlebar is attached to a trampoline to provide a steadying device. Inventor Tsai in United States patent publication 2016/0256722 published Sep. 8, 2016 entitled Bounding Table And The Installation Tool Of The Bounding Table provides a connection between a handlebar and an exercise trampoline, the disclosure of which is incorporated herein by reference.

### SUMMARY OF THE INVENTION

A trampoline clamp structure has a trampoline bounding bed attached to a trampoline frame. Trampoline legs extending downwardly from the trampoline frame. The trampoline legs include a right trampoline leg and a left trampoline leg. A trampoline handle has a pair of downwardly extending posts, namely a right post and a left post. A right clamp has a right outside retainer and a right inside retainer. The right outside retainer retains the right post. The right inside retainer retains the right trampoline leg. A left clamp has a left outside retainer and a left inside retainer. The left outside retainer retains the left post. The left inside retainer retains the left trampoline leg. At least one right outside retainer tab is formed on the right clamp. The one right outside retainer tab extends into a right clamp gap and abuts against both the right post and the right trampoline leg. The one left outside retainer tab is formed on the left clamp. The one left outside retainer tab extends into a left clamp gap and abuts against both the left post and the left trampoline leg. A right mid retainer indent is formed between the right outside retainer and the right inside retainer. A left mid retainer indent is formed between the left outside retainer and the left inside retainer. One right outside retainer tab is formed on the right mid retainer indent, and one left outside retainer tab is formed on the left mid retainer indent.

A right first inside retainer tab and a right second inside retainer tab both extend from the right mid retainer indent and have a left first inside retainer tab and a left second inside retainer tab both extending from the left mid retainer indent.

A right third inside retainer tab and a right fourth inside retainer tab both extend from the right mid retainer indent. A left third inside retainer tab and a left fourth inside retainer tab both extend from the left mid retainer indent.

The right third inside retainer tab and the right fourth inside retainer tab both extend from a lower edge of the right mid retainer indent. The left third inside retainer tab and the left fourth inside retainer tab both extend from a lower edge of the left mid retainer indent. A middle leg with a middle leg foot grip can be mounted between the right leg and the left leg. The handle has a handle apex above a right bend, and the right bend connects the handle apex to the right post. The handle apex is above a left bend, and connects the handle apex to the left post.

### BRIEF DESCRIPTION OF THE DRAWINGS

FIG. 1 is a rear view of the present invention.

FIG. 2 is a front view of the present invention.

FIG. 3 is an exploded view of the present invention.

FIG. 4 is an assembled view of the present invention.

FIG. 5 is a prior art structure.

FIG. 6 is a socket connection for a leg.

FIG. 7 is a socket connection for a leg.

FIG. 8 is a socket connection for a leg with only one outside retainer tab on the top and one on the bottom.

The following call out list of elements can be a useful guide in referencing the element numbers of the drawings.

| | |
|---|---|
| Upper Handle | 21 |
| Right Post | 22 |
| Left Post | 23 |
| Middle Foot Grip | 24 |
| Left Bend | 25 |
| Right Bend | 26 |
| Left Upward Bend | 27 |
| Right Upward Bend | 28 |
| Handle Apex | 29 |
| Bounding Bed | 31 |
| Spring Cover | 32 |
| Rear Leg | 33 |
| Rear Foot Grip | 34 |
| Left Leg | 35 |
| Left Foot Grip | 36 |
| Right Leg | 37 |
| Right Foot Grip | 38 |
| Middle Leg | 39 |
| Post Stabilizer | 40 |
| Left Clamp | 41 |
| Lower Right Post | 42 |
| Lower Left Post | 43 |
| Clamp Connector | 44 |
| Right Clamp | 45 |
| Right Clamp Gap | 47 |
| Left Clamp Gap | 48 |
| Clamp | 50 |
| Outside Retainer | 51 |
| Inside Retainer | 52 |
| First Inside Retainer Tab | 53 |
| Second Inside Retainer Tab | 54 |
| First Outside Retainer Tab | 55 |
| Second Outside Retainer Tab | 56 |
| Mid Retainer Indent | 57 |
| Second Outside Retainer Tab Tip | 58 |
| First Outside Retainer Tab Tip | 59 |
| Mid Retainer Indent Lower Edge | 61 |
| Mid Retainer Indent Upper Edge | 62 |
| Outside Retainer Lower Edge | 63 |
| Outside Retainer Upper Edge | 64 |
| Inside Retainer Lower Edge | 65 |
| Inside Retainer Upper Edge | 66 |
| Inside Retainer Inside Edge | 67 |
| Inside Retainer Outside Edge | 68 |
| Outside Retainer Inside Edge | 69 |
| Socket Connection | 70 |
| Leg Outside Surface | 71 |
| Leg Threaded Inside Surface | 72 |
| Trampoline Frame | 73 |
| Leg Mounting Member | 74 |
| Leg Mounting Weld | 75 |
| Leg Mounting Outside Thread | 76 |
| Third Outside Retainer Tab | 77 |
| Fourth Outside Retainer Tab | 78 |
| Spacer | 250 |

### DETAILED DESCRIPTION OF THE PREFERRED EMBODIMENT

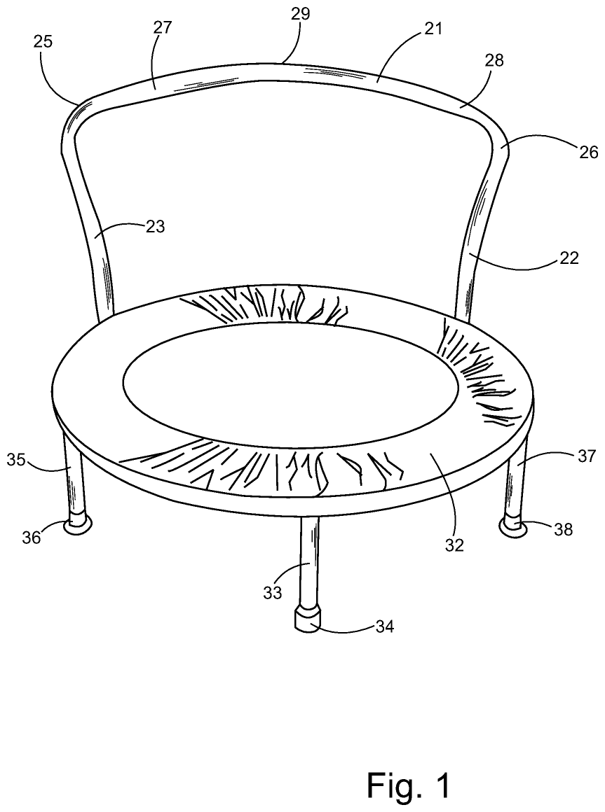

As seen in FIG. 1, the trampoline generally includes an upper handle 21 mounted across a right post 22 and a left post 23. The upper handle 21 has a left bend 25 and a right bend 26. The left bend 25 has a left upward bend 27 and the right bend 26 has a right upward bend 28. The handle has a highest point at a handle apex 29. The bounding bed 31 is stretched across a trampoline frame and held by springs. The springs are covered by spring cover 32. The trampoline frame is supported by a plurality of legs. For example, a rear leg 33 can have a rear foot grip 34. A left leg 35 can have a left foot grip 36. A right leg 37 can have a right foot grip 38. A middle leg 39 can have a middle foot grip 24.

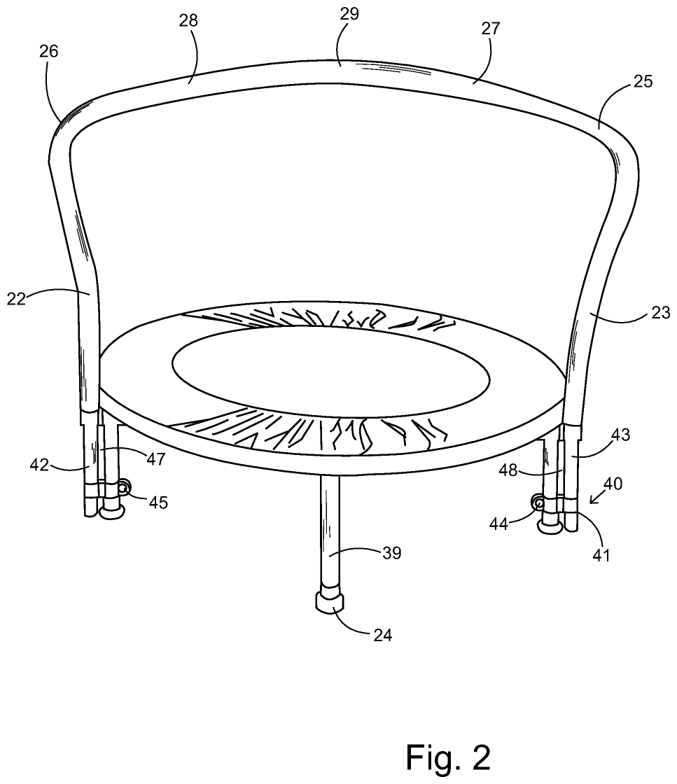

As seen in FIG. 2, a right post 22 extends downwardly from the right bend 26, and a left post 23 extends downwardly from the left bend 25. The left post 23 has a lower left post 43, and the right post as a lower right post 42. A post stabilizer 40 can be formed as a clamp such as a left clamp 41 or a right clamp 45. The post stabilizer 40 stabilizes the lower left post 43 and the lower right post 42 against the legs of the trampoline. The left clamp 41 and the right clamp 45 preferably both have a clamp connector 44. The post stabilizer 40 is preferably made of metal, and the posts, legs and frame of the trampoline are also preferably made of metal. The clamp connector 44 can be deployed in pairs on each leg connected to the posts, to provide an upper clamp connector and a lower clamp connector on each leg. A right clamp gap 47 sets off the right trampoline leg from the lower right post 42, and a left clamp gap 48 sets off the left trampoline leg from the lower left post 43.

The clamp is flat and preferably formed of a sheet of metal. The flat profile of the clamp allows the clamp to act as a metal strap that makes a robust connection. The inside surface of the clamp can be lined with a grip material such as an elastomeric material.

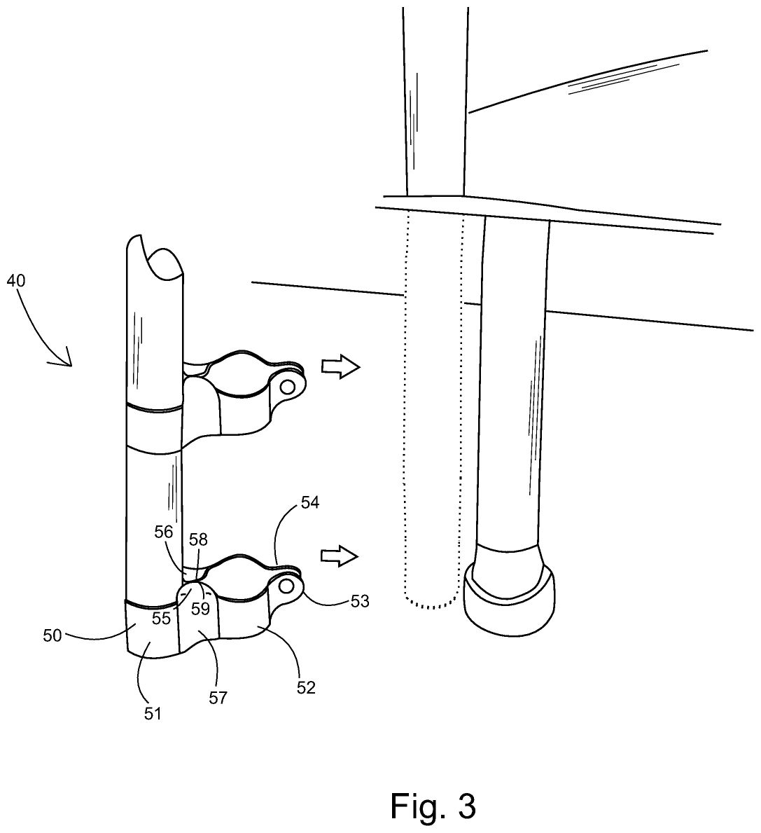

As seen in FIG. 3, the post stabilizer 40 has a clamp 50 with an outside retainer 51 and an inside retainer 52. The outside retainer 51 has a cylindrical profile wrapping around the lower left post 43. The inside retainer 54 also has a cylindrical profile for wrapping around a trampoline leg. The inside retainer has a first inside retainer tab 53 and a second inside retainer tab 54 that are connected together by the clamp connector 44. The clamp connector 44 can be a bolt or a screw or the like. The first inside retainer tab 53 and the second inside retainer tab 54 are preferably approximately parallel to each other after securing together around the trampoline leg via the clamp connector 44. The first inside retainer tab 53 and the second inside retainer tab 54 extend from the clamp 50. The clamp 50 is formed as a metal strip.

The clamp 50 also has a first outside retainer tab 55 and a second outside retainer tab 56 extending from the mid-retainer indent 57 of the clamp 50. The mid retainer indent 57 of the clamp 50 is concave which preferably bisects the outward bulge of the outside retainer 51 and the outward bulge of the inside retainer 52 to form an hourglass shape. The first outside retainer tab 55 has a first outside retainer tab tip 59 that points toward a second outside retainer tab tip 58 formed on the second outside retainer tab 56. The first outside retainer tab 55 and the second outside retainer tab 56 preferably have a parallel configuration. The first outside retainer tab tip 59 and second outside retainer tab tip 58 can be merged together such as by welding, or by being integrally formed together.

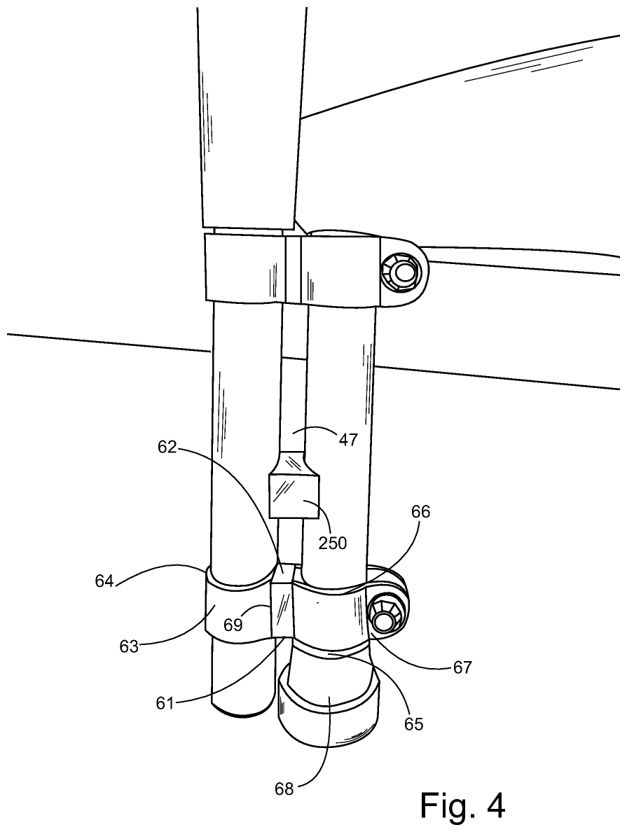

As seen in FIG. 4, a right clamp gap 47 can receive a spacer 250. The mid retainer indent has a mid retainer indent lower edge 61 and a mid retainer indent upper edge 62. Similarly, the outside retainer can have an outside retainer lower edge 63 and an outside retainer upper edge 64.

The inside retainer has an inside retainer lower edge 65 opposing and parallel to an inside retainer upper edge 66. The inside retainer may also have an inside retainer inside edge 67 and an inside retainer outside edge 68. The outside retainer inside edge 69 is preferably parallel to the inside retainer outside edge. The inside retainer outside edge 68 and the outside retainer inside edge 69 are preferably indented portions that may be formed as a crease on a sheet of bent metal. The first outside retainer tab 55 and second outside retainer tab 56 extend into the clamp gap 47.

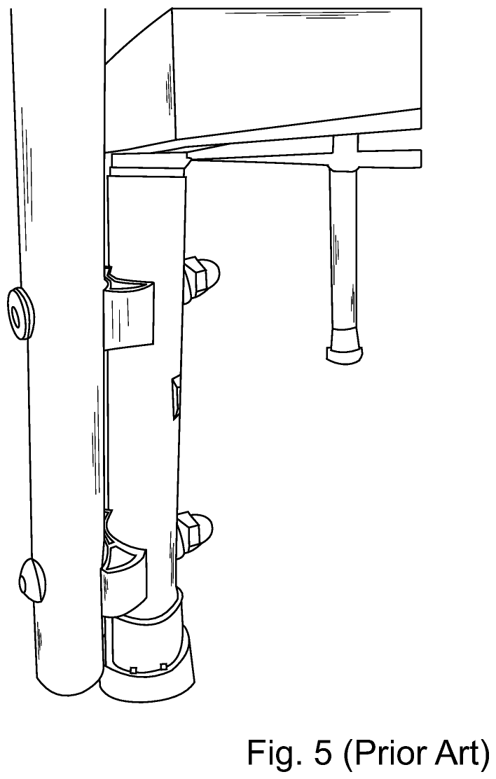

As seen in FIG. 5, a prior art connection structure has spacers and bolts for providing stability. The present invention does not require bolts to pass through the legs. A spacer 250 can be retained in the gap between the leg and the post by the clamps 50 instead of requiring the bolts.

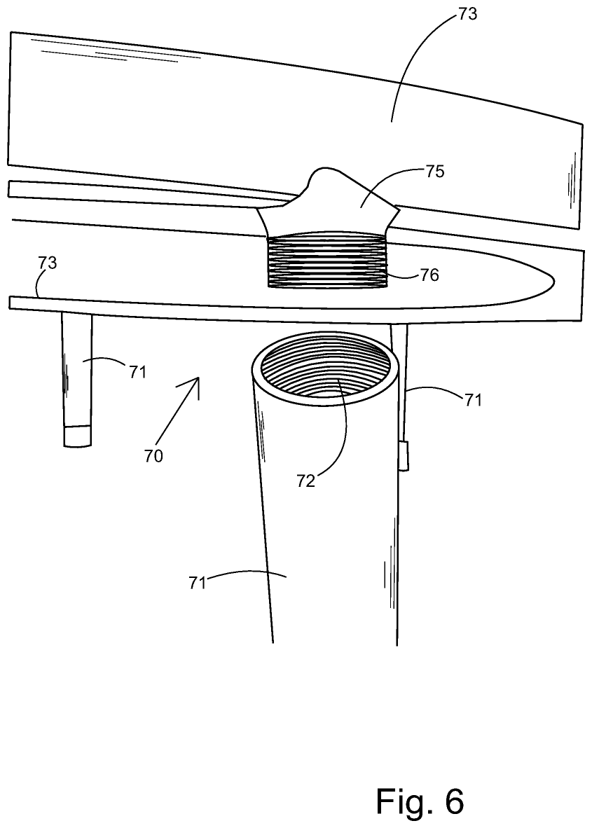

As seen in FIG. 6, a socket connection 70 has a leg threaded inside surface 72 connected to a leg mounting outside thread 76. The socket connection 70 has a smooth leg outside surface 71 1 connected to the trampoline frame 73 so that there is no visible screw threading. The leg mounting member 74 preferably has a leg mounting weld 75 connection to the trampoline frame 73.

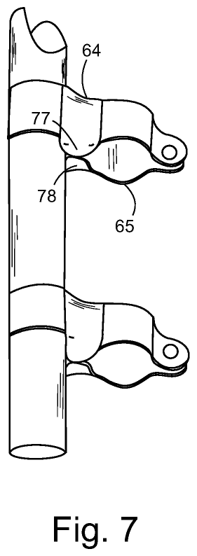

As seen in FIG. 7, a third outside retainer tab 77 and a fourth outside retainer tab 78 can extend from a mid retainer indent lower edge 61 analogously to how the second outside retainer tab 56 and the first outside retainer tab 55 extend from the mid-retainer indent upper edge 62. Thus, retainer tabs can extend from a lower edge of the mid-retainer indent as well as from the upper edge of the mid-retainer indent.

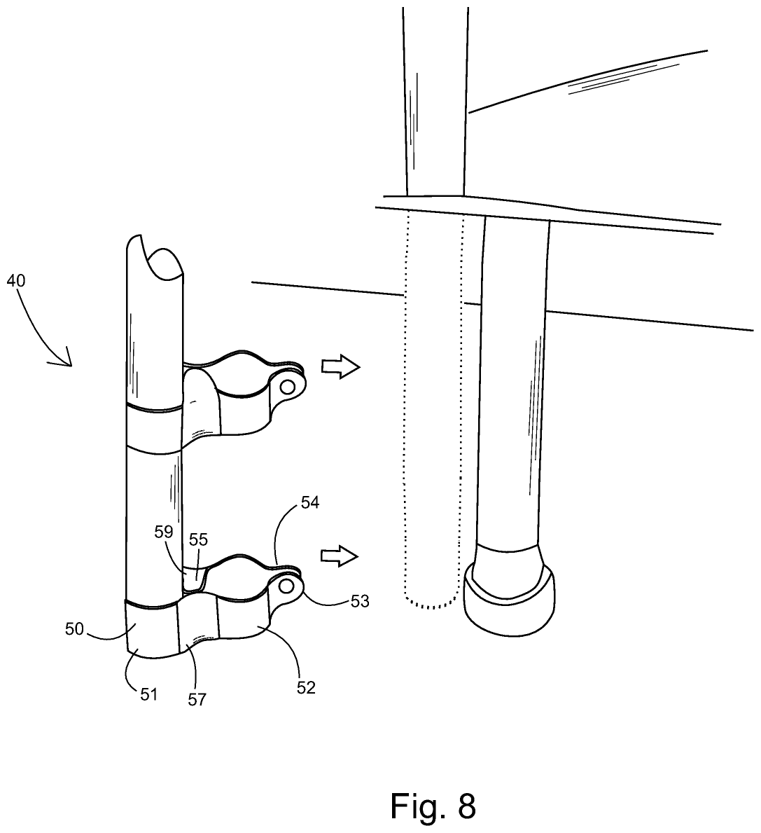

The present invention clamp has been shown to work on trampoline handles, but can also work on trampoline enclosure poles. As seen in FIG. 8, a socket connection for a leg can have only one outside retainer tab on the top and one on the bottom. When there is only one outside retainer tab, the outside retainer tab should be doubled and can extend from either the left or right mid retainer indent upper edge 62.

1. A trampoline clamp structure comprising:
a. a trampoline bounding bed attached to a trampoline frame;
b. trampoline legs extending downwardly from the trampoline frame, wherein the trampoline legs include a right trampoline leg and a left trampoline leg;
c. a trampoline handle having a pair of downwardly extending posts, namely a right post and a left post;
d. a right clamp having a right outside retainer and a right inside retainer, wherein the right outside retainer retains the right post, wherein the right inside retainer retains the right trampoline leg;
e. a left clamp having a left outside retainer and a left inside retainer, wherein the left outside retainer retains the left post, wherein the left inside retainer retains the left trampoline leg;
f. at least one right outside retainer tab formed on the right clamp, wherein the at least one right outside retainer tab extends into a right clamp gap and abuts against both the right post and the right trampoline leg; and
g. at least one left outside retainer tab formed on the left clamp, wherein the at least one left outside retainer tab extends into a left clamp gap and abuts against both the left post and the left trampoline leg.

2. The trampoline clamp structure of claim 1, further including a right mid retainer indent formed between the right outside retainer and the right inside retainer, and further including a left mid retainer indent formed between the left outside retainer and the left inside retainer, wherein the at least one right outside retainer tab is formed on the right mid retainer indent, and wherein the least one left outside retainer tab is formed on the left mid retainer indent.

3. The trampoline clamp structure of claim 1, further including a right first inside retainer tab and a right second inside retainer tab both extending from the right mid retainer indent; and further including a left first inside retainer tab and a left second inside retainer tab both extending from the left mid retainer indent.

4. The trampoline clamp structure of claim 3, further including a right third inside retainer tab and a right fourth inside retainer tab both extending from the right mid retainer indent; and further including a left third inside retainer tab and a left fourth inside retainer tab both extending from the left mid retainer indent.

5. The trampoline clamp structure of claim 4, wherein the right third inside retainer tab and the right fourth inside retainer tab both extending from a lower edge of the right mid retainer indent; and wherein left third inside retainer tab and the left fourth inside retainer tab both extend from a lower edge of the left mid retainer indent.

6. The trampoline clamp structure of claim 1, further including a middle leg with a middle leg foot grip mounted between the right leg and the left leg.

7. The trampoline clamp structure of claim 1, wherein the trampoline handle has a handle apex above a right bend, wherein the right bend connects the handle apex to the right post, wherein the handle apex is above a left bend, wherein the left bend connects the handle apex to the left post.

8. A trampoline clamp structure comprising:
a. a trampoline bounding bed attached to a trampoline frame;
b. trampoline legs extending downwardly from the trampoline frame, wherein the trampoline legs include a right trampoline leg and a left trampoline leg;
c. a trampoline handle having a pair of downwardly extending posts, namely a right post and a left post, wherein the trampoline handle has a handle apex above a right bend, wherein the right bend connects the handle apex to the right post, wherein the handle apex is above a left bend, wherein the left bend connects the handle apex to the left post;
d. a right clamp having a right outside retainer and a right inside retainer, wherein the right outside retainer retains the right post, wherein the right inside retainer retains the right trampoline leg;
e. a left clamp having a left outside retainer and a left inside retainer, wherein the left outside retainer retains the left post, wherein the left inside retainer retains the left trampoline leg;
f. at least one right outside retainer tab formed on the right clamp, wherein the at least one right outside retainer tab extends into a right clamp gap and abuts against both the right post and the right trampoline leg;
g. at least one left outside retainer tab formed on the left clamp, wherein the at least one left outside retainer tab extends into a left clamp gap and abuts against both the left post and the left trampoline leg; and
h. a middle leg with a middle leg foot grip mounted between the right leg and the left leg.

9. The trampoline clamp structure of claim 8, further including a right mid retainer indent formed between the right outside retainer and the right inside retainer, and further including a left mid retainer indent formed between the left outside retainer and the left inside retainer, wherein the at least one right outside retainer tab is formed on the right mid retainer indent, and wherein the least one left outside retainer tab is formed on the left mid retainer indent.

10. The trampoline clamp structure of claim 8, further including a right first inside retainer tab and a right second inside retainer tab both extending from the right mid retainer indent; and further including a left first inside retainer tab and a left second inside retainer tab both extending from the left mid retainer indent.

11. The trampoline clamp structure of claim 10, further including a right third inside retainer tab and a right fourth inside retainer tab both extending from the right mid retainer indent; and further including a left third inside retainer tab and a left fourth inside retainer tab both extending from the left mid retainer indent.

12. The trampoline clamp structure of claim 11, wherein the right third inside retainer tab and the right fourth inside retainer tab both extending from a lower edge of the right mid retainer indent; and wherein left third inside retainer tab and the left fourth inside retainer tab both extend from a lower edge of the left mid retainer indent.
